(19) United States
(12) Patent Application Publication
(10) Pub. No.: US 2009/0077127 A1
(43) Pub. Date: Mar. 19, 2009

(54) DEVICES AND METHODS ENABLING A USER TO MANAGE A PLURALITY OF OBJECTS AND IN PARTICULAR PAPER DOCUMENTS

(75) Inventors: Thomas Henry, Paris (FR); Matthieu Jacquier, Levallois-Perret (FR)

Correspondence Address: WESTMAN CHAMPLIN & KELLY, P.A., SUITE 1400, 900 SECOND AVENUE SOUTH, MINNEAPOLIS, MN, 55402-3244, US

(73) Assignee: Thomas Henry, Paris (FR)

(21) Appl. No.: 11/915,688

(22) PCT Filed: May 29, 2006
(86) PCT No.: PCT/EP2006/062685

§ 371 Date: Oct. 13, 2008

(30) Foreign Application Priority Data
May 27, 2005 (FR) 05/05410

(51) Int. Cl. G06F 17/30

(52) U.S. Cl. 707/103 Z; 707/E17.055

(57) ABSTRACT

A device is provided for managing a plurality of objects. The device archives at least one of the objects and obtains at least one specific reference to the at least one object. The device associates with the at least one reference at least one archiving location of the at least one object and characterizes a plurality of descriptive attributes associated with the at least one object. The device indexes the object enabling at least one of the attributes, called an indexing attribute, to be selected. The device stores for each archived object an n-uplet of data including the at least one reference of the object, the at least one location information and the at least one indexing attribute of the object.

### CROSS-REFERENCE TO RELATED APPLICATIONS

This Application is a Section 371 National Stage Application of International Application No. PCT/EP2006/062685, filed May 29, 2006 and published as WO2006/125831A1 on Nov. 30, 2006, not in English.

### FIELD OF THE DISCLOSURE

The field of the disclosure is that of archiving, filing and more generally the management of a group of objects. The related field of the disclosure is that of the management of information and/or a collection of documents.

More precisely the disclosure concerns a method and/or device enabling a user to manage a plurality of objects.

The disclosure applies to any kind of object and in particular to paper documents, photographs and electronic images thereof obtained by digitization, and electronic documents of all types (text, tables, images, etc.).

### BACKGROUND OF THE DISCLOSURE

1. Context

In the context of the rationalization of exchanges and an increase in the productivity of businesses, the grasp of the management of flows of goods and also flows of information now depends on a dynamic approach to the referencing systems and an identification of each object rather than just the initial batch to which it belongs.

Thus, for example, the logistic management techniques of many companies include the practice of traceability.

This tendency is accompanied moreover by an increase and intensification of flows, which requires companies and also individuals to have available management techniques and tools better adapted to their changing requirements.

Thus there is found a demand for stock and archive management techniques offering better adaptability and allowing sharing of information.

In terms of adaptability, it is expected for example for these techniques to be compatible with a great variety of data medium (electronic documents, paper documents, etc.). Indeed, because of habits and delays in adopting new legislative provisions, it is found that very many documents are still published in paper format: invoices, faxes, letters, advertisements, various declarations (tax, hiring staff, certificates, etc.). It is also expected for these techniques to make it possible to adapt to the diversification of objects and/or information. Techniques are also expected, the implementation of which does not require changing storage structures.

2. Techniques of the Prior Art

Thus a first technique is known that consists of classifying the objects according to a hierarchical arborescence comprising classes, sub-classes, etc.

This first known technique was the only one available before the appearance of data processing. In the context of document management the use of this technique amounts to filing the documents in cupboards, dossiers, sub-dossiers, folders, files, etc., or, for electronic documents, in directories, sub-directories, etc.

Thus, in this first technique, the objects can be found from knowledge of the receptacle in which they were filed.

For paper documents, a variant of this first technique consists of first making a copy of the document in digital format, so as to allow digital management of the documents and to keep a copy in electronic format.

A second technique is also known which consists of placing the objects, without arranging them, within the same receptacle and using a computer search tool relying on indexing means, for example of the full text type, to make it possible to find them.

3. Drawbacks of the Prior Art

A first drawback of the first known technique is that the time devoted to filing objects is lengthy.

A second drawback of the first known technique is that, in order to find an object, it is necessary to remember its existence and its characteristics in order to then find its location.

A third drawback of the first technique is that it is often necessary to know the filing principle in order to find the object.

Thus, for example for paper documents, it is often difficult to find information that has been filed by colleagues, predecessors, secretaries or bosses since their archiving methods are not known or not necessarily understood. It is also difficult to know which documents exist and which documents are accessible.

A drawback of the second known technique is the difficulty of finding the location of physical objects.

### SUMMARY

An embodiment of the invention thus concerns a device for managing a plurality of objects. Such a device comprises means of archiving at least one of said objects comprising:
means of obtaining at least one reference specific to said at least one object;
means of associating with said at least one reference at least one item of information on the archiving location of said at least one object;
means of characterizing a plurality of descriptive attributes associated with said at least one object;
means of indexing said object making it possible to select at least one of said attributes, referred to as the indexing attribute;
means of storing, for each archived object, an n-tuple of data comprising said at least one reference of said object, said at least one item of location information and said at least one indexing attribute of said object.

In this way a specific physical reference is obtained for each object, applied beforehand to the object (for example by means of an endorser) or where appropriate calculated and attributed and affixed by the device to the object. This reference may in particular be of the RFID chip, bar code, fingerprint or magnetic strip type, or a self-adhesive label or be applied manually to the object, entered by means of a keyboard, or be read by a reader integrated in such a device. Information on the location (the position in a storage bin, the position on a shelf, the location in a drawer, etc.) of an object associated with its reference and its indexing attributes is also known.

In addition the n-tuple supplied by the storage means makes it possible to recognise and store a trace of the object when it is extracted or consulted.

It should be noted that the objects to which one or more embodiments of the invention relate can also comprise several sub-objects and thus allow the management of a batch of sub-objects. In this case, the reference obtained can be associated with or be treated as information on commencement and/or finalisation of the object, such as for example when the object is a paper document comprising several pages.

The device also makes it possible to manage a set of objects and electronic elements (non-physical elements).

According to an advantageous characteristic, said association means also make it possible to associate with said at least one reference one item of additional information belonging to the group comprising:
information on the origin of said object;
information on the rights associated with said object;
information on said indexing means;
and said at least one stored n-tuple also comprises said at least one item of additional information.

Thus there is access to the information allowing computer processing. Other information including the addressee(s) of the document and the name of the user who registered the document can also be associated with the reference.

Advantageously, said at least one reference constitutes one of said attributes associated with at least one object.

Such a reference can also be meaningful for the user.

Preferentially, for each object, said at least one reference or at least one of said references is distinctive.

Each object can thus be marked individually.

According to an advantageous embodiment, said location information associated with said at least one item of reference successively obtained for objects archived successively by the archiving means define successive archiving locations.

Thus the objects are placed one after the other and possess items of location information that follow each other, which makes it possible to determine their location easily. This embodiment of the archiving proves to be particularly advantageous in the case of paper documents, for example by stacking the documents.

Preferentially, said characterization means are data processing means belonging to the group comprising:
scanner;
equipment for optical character recognition.

Thus the creation of the triplet takes place automatically. And then an electronic version of the paper document or of the photographic image is obtained. This makes it possible moreover to identify attributes, or key words, in the document making it possible to obtain or to indicate a reference for the object where applicable.

According to an advantageous embodiment, such a device comprises means of storing said objects in which each object is stored according to the item of location information associated with said at least one reference attributed to said object.

In this way specific storage locations are provided. It should be noted that the storage means can comprise one or more zones.

According to a particular aspect, said storage means comprise at least two zones in which at least one object can be placed, each zone being associated with a distinct zone identifier, and information relating to a zone identifier is associated with said at least one reference.

Thus it is possible to specify the zone in which the object is placed.

According to another particular aspect, each zone is associated with:
a receptacle in which objects are stored; and/or
at least one divider each defining at least one sub-zone in which objects are stored.

Thus, in the case of the management of paper documents, it is possible to store in receptacles (trays, etc.) and to reconstitute registers, able to be consulted directly by the user, without the help of computer equipment. A divider can also contain information concerning a group of documents of the same nature that it delimits (for example a set of invoices issued by the same energy provider), or an indication of time stamping to delimit for example all the documents archived on the same day. In addition, the dividers are recognised as such by the device, either automatically (for example by means of an RFID chip or a bar code placed on the divider) or by the supply of information in this regard by the user. Once the divider has been recognised, the device increments the counter associated with the marking of the dividers.

According to an advantageous aspect, at least one zone also comprises a receptacle belonging to the group comprising:
sealed tray;
safe;
dump;
shredder.

Thus access to the objects can be protected and the documents marked to be destroyed can no longer be extracted.

Advantageously such a device comprises:
means of importing n-tuples of data associated with objects archived by another device of the same nature as said device;
means of concatenating said imported n-tuples of data with the n-tuples of data associated with objects archived by said device.

Thus it is possible to export or import objects between several devices.

According to an original embodiment, such a device comprises elimination means for a given object of said stored n-tuple.

Thus the references of an object extracted from the archiving means can be eliminated.

An embodiment of the invention also concerns a device for managing a plurality of objects, each of said objects being associated with an n-tuple comprising at least one reference, at least one item of location information and at least one indexing attribute, and comprising means of dearchiving at least one of said objects comprising:
means of searching for and/or selecting said at least one object by virtue of said attributes indexed to it;
means of obtaining said at least one item of location information for said at least one sought and/or selected object.

In the entire document, dearchiving means the fact of being able to extract an object from the archiving means or in the case of a set of paper documents being able to consult a document without removing it from its location.

Thus it is possible to seek a specific object by carrying out a search on the attributes, obtain its reference and determine its location.

Advantageously the previous device comprises self-contained means belonging to the group comprising:
self-contained means of delivering said object according to said at least one item of location information;
self-contained means of indicating said object according to said at least one item of location information.

The delivery means can be implemented for example by a robot and the indicating means by a laser pointer.

According to a preferential aspect, said self-contained delivery means comprise means of recording said delivery.

Thus there remains a trace of the delivery operation.

Preferentially, said objects belong to the group comprising:
press cuttings;
stamps;
invoices;
questionnaires;
business cards;
forms;
medical prescriptions;
periodic statements;
post cards;
letters;
digital and/or analog recording media.

An embodiment of the invention applies in fact in particular to the management of paper documents and electronic documents. The digital and/or analog recording media to which an exemplary embodiment of the invention relates are of any type and in particular optical media (compact disc, DVD), hard disks, flash memories, vinyl disks and cassettes.

An embodiment of the invention also concerns a method for managing a plurality of objects, including a step of archiving at least one of said objects comprising:
a step of obtaining at least one reference specific to said at least one object;
a step of associating with said at least one reference at least one item of archiving location information for said at least one object;
a step of characterizing a plurality of descriptive attributes associated with said at least one object;
a step of indexing said at least one object making it possible to select at least one of said attributes, referred to as the indexing attribute;
a step of storing, for each archived object, an n-tuple of data comprising said at least one reference of said object, said at least one item of location information and said at least one indexing attribute of said object.

Advantageously, such a method comprises a step of dearchiving at least one of said objects comprising:
a step of searching for and/or selecting said at least one object by virtue of said attributes indexed to it;
a step of obtaining said at least one item of location information for said at least one object sought and/or selected.

According to a preferential aspect of an embodiment of the invention such a method for managing a plurality of objects also comprises:
means of detecting that an object to be archived has already been the subject of an archiving by said archiving means;
means, activated in the case of positive detection by said detection means, of replacing the n-tuple of data comprising said at least one reference, said at least one item of location information and said at least one indexing attribute of said object already archived by a new n-tuple comprising a new item of location information.

Thus an object dearchived or extracted for example for consultation if it is a case of a paper document can be replaced at any location and new item of location information is then automatically attributed to it. It should be noted then that the other data of the n-tuple remain unchanged.

An embodiment of the invention also concerns a computer program product comprising program code instructions for executing at least one step of the above methods and corresponding saving means.

### BRIEF DESCRIPTION OF THE DRAWINGS

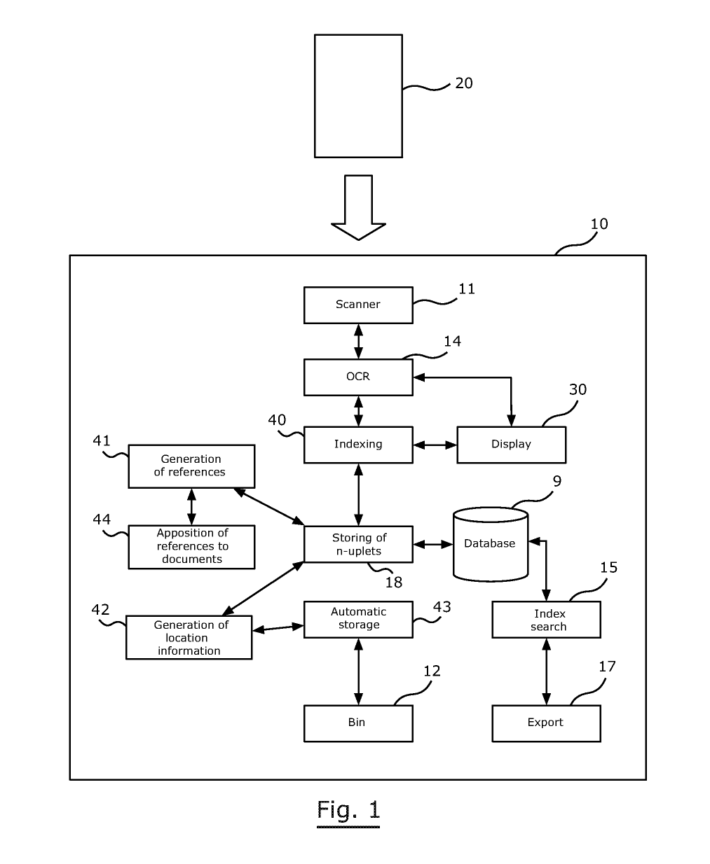

Other characteristics will emerge from a reading of the description of a particular embodiment and of the diagram of the accompanying FIG. 1 illustrating in schematic form the elements of a system for managing a paper document base.

### DETAILED DESCRIPTION OF ILLUSTRATIVE EMBODIMENTS

As specified previously, an embodiment of the invention thus concerns a device for managing a plurality of objects.

In the remainder of the present document, a particular embodiment of a system according to the invention intended for managing paper documents is presented. This system combines the means of the archiving and dearchiving devices according to an embodiment of the invention.

As illustrated in FIG. 1, this system 10 for managing paper documents 20 comprises:
characterization means, also referred to as a scanner, 11;
a character recognition tool (OCR) 14;
indexing means 40;
display means 30;
means 41 of generating document references;
means 44 of affixing a reference to the document (for example by sticking on a label comprising this reference;)
means 42 of generating document archiving location information;
means 18 of storing, in a database 9, n-tuples each comprising a document reference, archiving location information and attributes (in particular indexing attributes);
automatic storage means 43 connected to a receptacle 12, also referred to as a filing tray;
indexed search means 15 making it possible, during a phase of dearchiving or consulting of a previously archived document, to find the required document from a search based on one or more indexing attributes of this document;
export means 17 associated with file compression means, enabling the user to export in compressed form the documents determined in a virtual document case, in particular in the form of a zip file.

The scanner 11 is used to digitise the documents. It should be noted that, without departing from the scope of the disclosure, a facsimile machine or a photocopier having this function available can also be used.

This device also comprises, in a variant that is not illustrated:
downloading means enabling the user to download documents determined among the documents in the list of documents;
means of sending by email;
annotation means for annotating all the documents;
means for saving the images of all the documents on a remote server.

In a variant of this embodiment, it can be envisaged that the system also comprises second storage means for storing in the database 9 information concerning the paper documents, in particular a history of the digitizations performed, and a history of the consultations and exportations performed by the user.

The user can thus very quickly archive the documents and have access instantaneously to the content and rapidly to the physical document.

The functioning of the system of FIG. 1 during the archiving of a paper document 20 is now presented in more detail. The document is scanned and then a character recognition is carried out, by virtue of suitable software of the OCR type, in order to obtain a plurality of attributes describing the document. The document is indexed by selecting certain attributes known as indexing attributes. A reference is generated that is affixed to the document (for example by sticking on a label bearing this reference). Archiving location information is also generated for this document. An n-tuple specific to the document to be archived and comprising the aforementioned reference, the aforementioned archiving location information and the aforementioned indexing attributes is stored in the database. In addition, the document, after it is labelled, is automatically stored in the tray 12 for example by simple stacking in a chronological order.

In a variant that is not illustrated, the document 20 to be archived already comprises a reference (for example on a label stuck to this document). In this case, compared with the example in FIG. 1, the reference generator 41 and the reference affixing means 44 are replaced by a mean of reading the reference already present on the document. These reading means use for example the results of the character recognition carried out on the document.

Regularly, the user can introduce a coloured and/or bound card and/or numbered divider into the filing tray. These dividers structure the stack of documents (or volume) in several parts (or chapters) composed of several pages. These dividers can contain certain fields such as a title, these fields will make it possible to structure the file finally obtained. These dividers can also contain key words or attributes that will be added as comments to the paper documents subsequently scanned. During the search, the user enters a request for finding the document sought (for example the key words contained in the document). The search engine (not illustrated) displays the results of the search in the form of a list of documents.

For each document, the user can:
display in advance a glimpse of the document;
edit the image of the document (for example in pdf format, the system keeping a trace of this action;)
comment on the documents, the commentary will be legible at each preview of the document, and the commentaries will also be searchable;
compare two documents, the system will indicate all the additions and deletions made between the two documents;
consult the history of each document (who has looked at it and when, extracted, etc.).

For a set of documents selected among the documents in the list of documents, the user can:
send documents by email, the system keeping a trace of this action;
download or delete documents, the system keeping a trace of this action.

During consultation, if the display of a copy of the document is not sufficient, the user can consult the original.

After having previewed the document, the user can request the physical location of the document from the system. The system indicates the physical location of the document (for example “volume 2, page 75 (between dividers 5 and 6)”).

The system keeps a trace that this user has had access to the physical document. If the user wishes to extract the document, he so specifies, and the software keeps a trace of this.

After extraction, the document can be:
replaced in its original position in its stack, it then keeps its sticker/thumb index and neither its indexing nor its location are modified by the system; or
re-indexed, its indexing and its location and its item of location information are deleted from the system (which keeps a trace of it all the same), the user puts the document into the scanner again, which will treat it as a new document and it will therefore be filed simply, without the user having to take account of its initial location; or
replaced in a different position from its original position, which changes the item of location information, while its reference and indexing attributes are kept.

In another variant of this embodiment, such a device comprises a module for backing up a copy of its document base. Thus, even in the event of a fire, a copy of all the documents is kept in a secure place, in particular on a remote server.

In yet another variant of this embodiment, such a device comprises a module for publishing a contents list of the file that shows the various parts, or the chapters, possibly separated by dividers, and the various pages, possibly accompanied by their comments and/or a summary of their content.

It is clear that it is possible to envisage using the method and/or device according to an embodiment of the invention for managing any other set of any objects without departing from the scope of the disclosure.

In a particular embodiment of the invention, a device can manage several receptacles simultaneously, in particular in order to direct the objects of different sizes, different origins or different authors into specific receptacles.

In another embodiment of the invention, the various receptacles or trays can constitute the different drawers of the same assembly.

In addition it can be envisaged for the device according to an embodiment of the invention to comprise the elements belonging to the group comprising:
recognition means for informing the computer system of the tray where the object is situated;
interface with accountancy software, or address book;
robot for automatic changing of the receptacles of the storage means;
means of communication with a delocalized computer system by a network;
means of exporting n-tuples in various forms, in particular in the form of a table of contents or systemic representation (of the mind mapping type, with recognition of key concepts);
means of remote interrogation via SMS (Short Message Service), PDAs (Personal Digital Assistant) or electronic voice syntheses.

It can also be envisaged for the device to be placed directly downstream of a facsimile machine or printer without departing from the scope of the disclosure.

An aspect of the disclosure provides a technique of managing a plurality of objects allowing to fit onto the diversification of the characteristics of the objects in a group of objects to be managed.

An aspect of the disclosure provides a technique allowing automatic indexing of the objects without human intervention.

Another aspect of the disclosure provides a technique for finding the characteristics and/or content of an object or of a paper document without needing to reach the original.

Another aspect of the disclosure provides a technique for specifying the exact location of the document sought and thus avoiding a user having to manually search in the storage and/or filing receptacles.

Another aspect of the disclosure provides a technique enabling the user, after having reached and used an object or having consulted a document, to store it simply, without having to remember the original location.

The user can keep a copy of his documentary base for reasons of security.

Another aspect of the disclosure provides a technique permitting fully automated and computerized management of the objects to be managed.

Yet another aspect of the disclosure provides a technique simplifying the use of the same base by several users by completely harmonizing the filing methods.

Yet another aspect of the disclosure provides a technique using search tools having a more user-friendly and intuitive interface.

Although the present disclosure has been described with reference to one or more examples, workers skilled in the art will recognize that changes may be made in form and detail without departing from the scope of the disclosure and/or the appended claims.

1. A device for managing a plurality of objects, which comprises means of archiving at least one of said objects, the means of archiving comprising:
means of obtaining at least one specific reference to said at least one object;
means of associating with said at least one reference at least one item of information on an archiving location of said at least one object;
means of characterizing a plurality of descriptive attributes associated with said at least one object;
means of indexing said object making it possible to select at least one of said attributes, referred to as an indexing attribute;
means of storing, for each archived object, an n-tuple of data comprising said at least one reference of said object, said at least one item of location information and said at least one indexing attribute of said object.

2. The device for managing a plurality of objects according to claim 1, wherein said association means also make it possible to associate with said at least one reference one item of additional information belonging to the group comprising:
information on an origin of said object;
information on rights associated with said object;
information on said indexing means;
and wherein said at least one n-tuple stored also comprises said at least one item of additional information.

3. The device for managing a plurality of objects according to claim 1, wherein said at least one reference constitutes one of said attributes associated with said at least one object.

4. The device for managing a plurality of objects according to claim 1, wherein, for each object, said at least one reference or at least one of said references is distinctive.

5. The device for managing a plurality of objects according to claim 1, wherein said item of location information associated with said at least one reference, successively obtained for objects archived successively by the archiving means, define successive archiving locations.

6. The device for managing a plurality of objects according to claim 1, wherein said characterisation means are data processing means belonging to the group comprising:
scanner;
equipment for optical character recognition.

7. The device for managing a plurality of objects according to claim 1, wherein the device comprises means of storing said objects in which each object is stored, according to the item of the location information associated with said at least one reference obtained for said object.

8. The device for managing a plurality of objects according to claim 7, wherein said storage means comprise at least two zones in which at least one object can be placed, each zone being associated with a distinct zone identifier, and in that said association means also make it possible to associate with said at least one reference an item of information relating to a zone identifier.

9. The device for managing a plurality of objects according to claim 8, wherein each zone comprises:
a receptacle in which objects are stored; and
at least one divider each defining at least one sub-zone in which objects are stored.

10. The device for managing a plurality of objects according to claim 8 wherein at least one zone comprises a receptacle belonging to the group comprising:
sealed tray;
safe;
dump;
shredder.

11. The device for managing a plurality of objects according to claim 1, wherein the device comprises:
means of importing n-tuples of data associated with objects archived by another device of the same nature as said device; and
means of concatenating said imported n-tuples of data with the n-tuples of data associated with objects archived by said device.

12. The device for managing a plurality of objects according to claim 1, wherein the device comprises deletion means for a given object of said stored n-tuple.

13. A device for managing a plurality of objects, each of said objects being associated with an n-tuple comprising at least one reference, at least one item of location information and at least one indexing attribute, wherein the device comprises means of dearchiving at least one of said objects comprising:
means of searching for and/or selecting said at least one object by virtue of said attributes indexed to it; and
means of obtaining said at least one item of location information for said at least one sought and/or selected object.

14. The device for managing a plurality of objects according to claim 13, wherein the device comprises self-contained means belonging to the group comprising:
self-contained means of delivering said object according to said at least one item of location information;
self-contained means of indicating said object according to said at least one item of location information.

15. The device for managing a plurality of objects according to claim 14, wherein said self-contained delivery means comprise means of consignment of said delivery.

16. The device for managing a plurality of objects according to claim 1, wherein said objects belong to the group comprising:
press cuttings;
stamps;
invoices;
questionnaires;
business cards;
forms;
medical prescriptions;
periodic statements;
post cards;
letters;
digital and/or analog recording media.

17. A method of managing a plurality of objects, comprising a step of archiving at least one of said objects comprising:
a step of obtaining at least one reference specific to said at least one object;
a step of associating with said at least one reference at least one item of archiving location information for said at least one object;
a step of characterizing a plurality of descriptive attributes associated with said at least one object;
a step of indexing said at least one object making it possible to select at least one of said attributes, referred to as an indexing attribute;
a step of storing, for each archived object, an n-tuple of data comprising said at least one reference of said object, said at least one item of location information and said at least one indexing attribute of said object.

18. A method of managing a plurality of objects, each of said objects being associated with at least one n-tuple comprising at least one reference, at least one item of location information and at least one indexing attribute, wherein the method comprises a step of dearchiving at least one of said objects comprising:
a step of searching for and/or selecting said at least one object by virtue of said attributes indexed to it; and
a step of obtaining said at least one item of location information for said at least one object sought and/or selected.

19. The managing a plurality of objects according to claim 17, wherein the method also comprises:
a step of detecting that an object to be archived has already been subject of an archiving by archiving means;
a step of replacing the n-tuple of data comprising said at least one reference, activated in the case of positive detection by detection means, said at least one item of location information and said at least one indexing attribute of said object already archived by a new n-tuple comprising a new item of location information.

20. A computer program product stored on a carrier that can be read by a computer and/or can be executed by microprocessor, wherein the computer program product comprises program code instructions for executing the following steps, when it is run on a computer:
archiving at least one of said objects comprising:
a step of obtaining at least one reference specific to said at least one object;
a step of associating with said at least one reference at least one item of archiving location information for said at least one object;
a step of characterizing a plurality of descriptive attributes associated with said at least one object;
a step of indexing said at least one object making it possible to select at least one of said attributes, referred to as an indexing attribute;
a step of storing, for each archived object, an n-tuple of data comprising said at least one reference of said object, said at least one item of location information and said at least one indexing attribute of said object.

21. (canceled)

22. The device for managing a plurality of objects according to claim 1, wherein the device also comprises:
means of detecting that an object to be archived has already been the subject to an archiving by said archiving means;
means, activated in the case of positive detection by said detection means, of replacing the n-tuple of data comprising said at least one reference, said at least one item of location information and said at least one indexing attribute of said object already archived by a new n-tuple comprising a new item of location information.

23. The device for managing a plurality of objects according to claim 13, wherein said objects belong to the group comprising:
press cuttings;
stamps;
invoices;
questionnaires;
business cards;
forms;
medical prescriptions;
periodic statements;
post cards;
letters;
digital and/or analog recording media.

24. The device for managing a plurality of objects according to claim 13, wherein the device also comprises:
means of detecting that an object to be archived has already been subject to an archiving by said archiving means;
means, activated in the case of positive detection by said detection means, of replacing the n-tuple of data comprising said at least one reference, said at least one item of location information and said at least one indexing attribute of said object already archived by a new n-tuple comprising a new item of location information.

25. The managing a plurality of objects according to claim 18, wherein the method also comprises:
detecting that an object to be archived has already been subject of an archiving by archiving means;
replacing the n-tuple of data comprising said at least one reference, activated in the case of positive detection by detection means, said at least one item of location information and said at least one indexing attribute of said object already archived by a new n-tuple comprising a new item of location information.
